(19) United States
(12) Patent Application Publication
(10) Pub. No.: US 2015/0116802 A1
(43) Pub. Date: Apr. 30, 2015

(54) Phase-Switched Optical Flip-Flops Using Two-Input Bistable Resonators and Methods

(71) Applicant: University of Rochester, Rochester, NY (US)

(72) Inventors: Govind Agrawal, Rochester, NY (US); Brian Daniel, Rochester, NY (US)

(21) Appl. No.: 14/062,874

(22) Filed: Oct. 24, 2013

(51) Int. Cl. G02F 3/02

(52) U.S. Cl. CPC G02F 3/026
USPC 359/107

(57) ABSTRACT

A two-input bistable resonator that can be switched in a robust way by phase modulation of the input beams is presented. An optical flip-flop of the present invention may be embodied as a two-input Kerr resonator. The disclosed switching mechanism is compatible with cross-phase modulation induced by set and reset pulses for realization of an ultrafast, passive, all-optical memory element.

### FIELD OF THE INVENTION

The present disclosure relates to optical circuits, and more particularly to optical flip flop circuits.

### BACKGROUND OF THE INVENTION

Optical flip-flops are the key elements of all-optical memory and buffering devices. The development of such devices remains in its infancy, even though flip-flops would be valuable in contemporary communication networks. The reason for this is that flip-flops are not yet fast, robust, and low-power enough to be used in the large numbers that these applications demand. The most common means of implementing optical flip-flops is the use of active semiconductor devices. Both semiconductor optical amplifiers and semiconductor lasers have been widely used for this purpose. An alternative would be to use the Kerr effect in a passive, bistable resonator. This second approach has two potential advantages. First, passive flip-flops do not require current injection and devices that require cascading of such elements could be implemented with lower power requirements. Second, the Kerr effect has an almost instantaneous material response. As a result, switching speeds are not limited by the nonlinear medium but by the photon lifetime of the cavity, which can, in principle, be engineered to be as fast as necessary. Implementation of Kerr flip-flops using microresonators has proven to be difficult. When the optical power in a resonator is large, material absorption significantly heats it. The resulting thermo-optic change in refractive index is much stronger and slower than the Kerr effect, and as a result, switching between the “on” and “off” states is limited to microsecond time scales. Techniques for getting around this limitation have included cooling the cavity to cryogenic temperatures and using pulsed input fields with temporal durations much smaller than the cavity's thermal response time.

Two-input bistability, for which the resonator is equally full of light in both stable states, has the potential to circumvent this limitation. In such a device the thermal effect would be equally strong in both ‘on’ and ‘off’ states, producing a background refractive index change that does not respond on a time scale comparable to that of the much faster Kerr nonlinearity.

### BRIEF SUMMARY OF THE INVENTION

The present invention can be embodied as a two-input bistable resonator that can be switched in a robust way by phase modulation of the input beams. An optical flip-flop of the present invention may be embodied as a two-input Kerr resonator. The disclosed switching mechanism is compatible with cross-phase modulation induced by set and reset pulses for realization of an ultrafast, passive, all-optical memory element.

### DESCRIPTION OF THE DRAWINGS

For a fuller understanding of the nature and objects of the invention, reference should be made to the following detailed description taken in conjunction with the accompanying drawings, in which:

FIG. 1 is a schematic of a device according to an embodiment of the present invention;

FIG. 2A describes a first stable state of the resonator under appropriate biasing conditions, wherein the dashed and solid lines show the Lorentzian responses of the two cavity modes in each stable state;

FIG. 2B describes a second stable state of the resonator of FIG. 2A;

FIG. 3A shows boundaries for the symmetric (dashed curve) and asymmetric (solid curves) solutions in the Δω₀,P₀ plane;

FIG. 3B shows the available transmission states when detuning of beam 2 deviates from the chosen bias point, wherein solid and dashed lines show stable and unstable solutions respectively; and

FIG. 4A shows the transmission values (T₁ and T₂) over time at the output ports of an optical flip-flop according to another embodiment of the present during a numerical simulation of phase-induced switching when the input beams are kept at constant power;

FIG. 4B shows the phases (φ₁ and φ₂) over time of the input beams used in the numerical simulation of FIG. 4A showing the input beam phase changes that correspond to the output port transmission values;

FIG. 5 is a flowchart depicting a method according to another embodiment of the present invention;

FIG. 6 is a diagram of a system according to another embodiment of the present invention;

FIG. 7 (top) depicts a device according to another embodiment of the present invention; (bottom graphs) show where two input fields at frequencies ω₀₁ and ω₀₂ couple to two different resonator modes with resonance frequencies ω₁ and ω₂, and wherein in the first state, input field Aᵢₙ⁽¹⁾ fills the cavity with light, causing a Kerr-induced redshift of the resonance frequencies, and wherein the redshift of the mode 2 resonance is twice as large because the XPM is twice as strong as the SPM (in the second stable state, the roles of the input fields are reversed);

FIG. 8 is a map of possible bias points of an exemplary device when the input fields have the same power P₀ and detuning Δω₀, wherein the solid and dashed curves bound regions for which asymmetric solutions exist and multiple symmetric solutions exist, respectively, and the ideal bias points lie in the shaded region;

FIG. 9 shows stable and unstable states of an exemplary device when the detuning of input field 2 deviates from the initial biasing at Δω₂τₚₕ=Δω₁τₚₕ=−2, wherein the shaded region indicates where the flip-flop can be switched by modulating the phase of input field 2;

FIG. 10 shows phase switching for four different values of the maximum phase shift φ₀ (from top to bottom φ₀=2, 2.3, 3.14, and 6.28) when the duration of the modulation is fixed at T₀=2τₚₕ, wherein temporal variations of the phase (left) and transmission (right) are shown for input fields 1 (solid curves) and 2 (dashed curves); and

FIG. 11 shows phase switching for four different values of T₀ (from top to bottom, T₀=0.5τₚₕ, τₚₕ, 4τₚₕ, and 5τₚₕ) when the maximum phase shift is fixed at φ₀=π, wherein temporal variations of the phase (left) and transmission (right) are shown for input fields 1 (solid curves) and 2 (dashed curves).

### DETAILED DESCRIPTION OF THE INVENTION

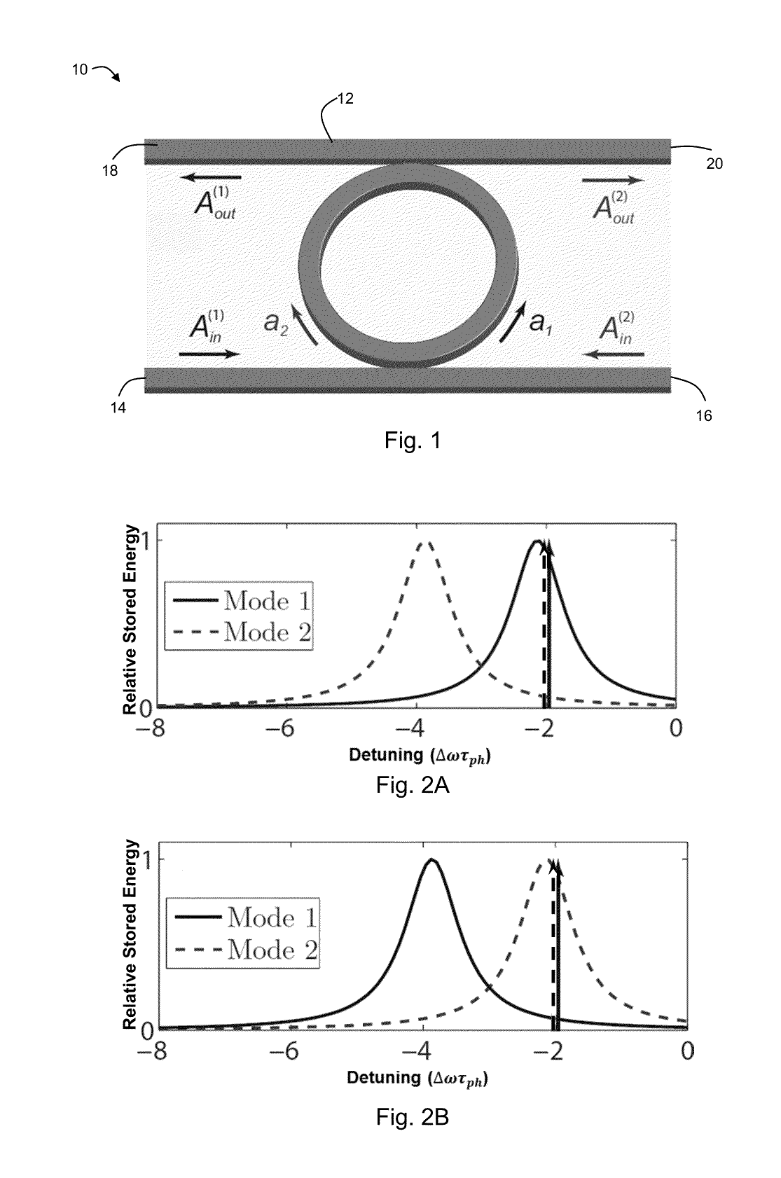

The present invention may be embodied as an optical flip-flop 10, shown schematically in FIG. 1. In an embodiment, the flip-flop 10 comprises a micro-ring resonator 12 having two inputs 14, 16 and two outputs 18, 20. In this embodiment, two resonator modes (a₁ and a₂), excited by two input beams (Aᵢₙ⁽¹⁾ and Aᵢₙ⁽²⁾) near a specific resonance frequency ωᵣ, propagate in the clockwise (a₂) and counter-clockwise (a₁) directions. It should be noted that the present description is an exemplary embodiment, and that the present invention and the results disclosed herein are applicable to any kind of dielectric resonator (such as, for example, photonic-crystal micro-cavities and whispering-gallery-mode resonators) so long as the two excited modes are distinguishable (e.g., by having different resonance frequencies, etc.) The physical origin of two-input bistability is the asymmetry between Kerr-induced self- and cross-phase modulations (“SPM” and “XPM,” respectively). For example, in the case when mode a₁ is much more intense than mode a₂, mode a₁ experiences an SPM-induced change Δn_{NL} in the medium's refractive index, causing the resonance frequency to shift by an amount −ωᵣΔn_{NL}/n₀, where n₀ is the linear refractive index of the medium inside the resonator. The clockwise wave a₂, however, experiences an XPM-induced change of 2Δn_{NL}, and its resonance frequency shifts by twice that amount.

When both input fields (Aᵢₙ⁽¹⁾ and Aᵢₙ⁽²⁾) are equally intense and equally detuned from resonance, the asymmetry between SPM and XPM effects can lead to the existence of two stable states, as illustrated in FIGS. 2A and 2B for the case when both input fields are detuned from the low-intensity resonance frequency by an amount Δω=2/τₚₕ, where τₚₖ is the photon lifetime of the ring cavity. In FIG. 2A, the input Aᵢₙ⁽¹⁾ (solid arrow) is on resonance with the cavity mode, while Aᵢₙ⁽²⁾ is off resonance. The opposite happens in FIG. 2B where Aᵢₙ⁽²⁾ is on resonance and Aᵢₙ⁽¹⁾ is off resonance.

To quantify the performance of the two-input optical flip-flop of the present embodiment, the methodology disclosed in B. A. Daniel, D. N. Maywar, and G. P. Agrawal, “Dynamic mode theory of optical resonators undergoing refractive index changes,” J. Opt. Soc. Am. B 28, 2207-2215 (2011), incorporated herein by reference, may be used. Use of such methodology leads to the following two coupled nonlinear equations for the mode amplitudes a₁ and a₂:

$$\begin{matrix}\frac{d {a}_{1}}{d t} = i Δ {ω}_{1} {a}_{1} - \frac{{a}_{1}}{2 {τ}_{ph}} + κ {A}_{in}^{( 1 )} ( t ) + i ( {γ}_{11} {\vert {a}_{1} \vert}^{2} + 2 {γ}_{12} {\vert {a}_{2} \vert}^{2} ) {a}_{1} , & ( 1 ) \\ \frac{d {a}_{2}}{d t} = i Δ {ω}_{2} {a}_{2} - \frac{{a}_{2}}{2 {τ}_{ph}} + κ {A}_{in}^{( 2 )} ( t ) + i ( {γ}_{22} {\vert {a}_{1} \vert}^{2} + 2 {γ}_{21} {\vert {a}_{2} \vert}^{2} ) {a}_{2} , & ( 2 )\end{matrix}$$

where |aₖ(t)|² represents the optical energy stored in mode k at time t, Δωₖ=ωₖ−ωᵣ is the detuning from the cavity resonance ωᵣ, and Aᵢₙ^{(k)} is the input field normalized so that |Aᵢₙ^{(k)}|² is the optical power. Coupling of the input field into the resonator is governed by κ; it is given by κ=(2τₚₕ)^{-1/2} when cavity losses from absorption and scattering are relatively small. The SPM and XPM effects are included through the nonlinear parameters γₖₗ given by:

$${γ}_{k 1} = \frac{{ω}_{k} {n}_{2} c {η}_{kl}}{{{n}_{0}^{2} ( {V}_{k} {V}_{l} )}^{1 / 2}} , \qquad ( 3 )$$

where n₂ is the Kerr coefficient, Vₖ is the effective mode volume, and nₖₗ is a parameter which measures how well the resonator mode overlaps with the nonlinear medium. Typically nₖₗ≈1 and Vₖ≈Vₗ. In what follows, the approximation γ₁₂≈γ₂₂≈γ₁₁=γ is made and equations (1) and (2) are solved numerically. The power transmissivity of the two output ports is calculated using:

Tₖ=|Aₒᵤₜ^{(k)}/Aᵢₙ^{(k)}|²=|κaₖ/Aᵢₙ^{(k)}|². (4)

Before considering the phase-switching dynamics, the stable steady states of the optical flip-flop are identified by considering the continuous-wave (“CW”) case for which Aᵢₙ^{(k)}=\sqrt{Pₖ} is a constant. The steady-state solutions are found by setting the time derivatives in equations (1) and (2) equal to zero. Introducing the mode energy Eₖ=|aₖ|², the following set of two algebraic equations (k=1 or 2) are found:

Eₖ[(1/2τₚₕ)²+(AΔωₖ+γEₖ+2γE₃₋₅)²]=κ²Pₖ. (5)

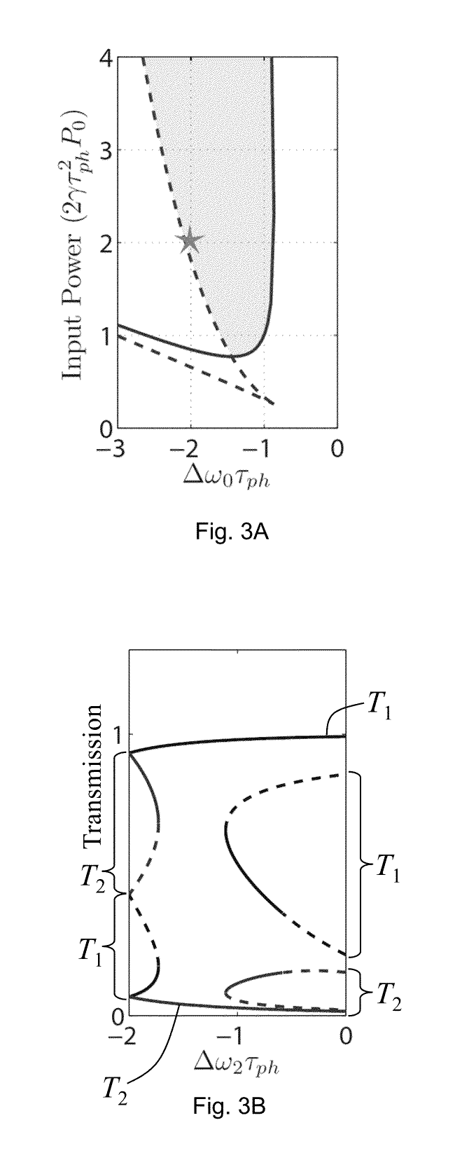

Considering a flip-flop which is biased such that the two input beams have the same power (P₁=P₂=P₀) and the same detuning (Δω=Δω₂=Δω₀), the solutions of equation 5 can be divided into two categories: (1) symmetric (E₁=E₂) solutions, and (2) asymmetric (E₁≠E₂) solutions. The asymmetric solutions come in pairs since the roles of E₁ and E₂ can be reversed. Using known techniques, FIG. 3A shows important boundaries for each of these two groups of solutions in the Δω₀,P₀ plane. The solid curve bounds the region in which asymmetric solutions exist and the dashed curve bounds a region for which there is more than one symmetric solution (at least one symmetric solution is found to exist everywhere in the plane). In the presence of an asymmetric solution, one of the symmetric solutions always becomes unstable. For flip-flop operation, an advantageous bias point would have only two stable asymmetric states, similar to the ones shown in FIGS. 2A and 2B. The set of such bias points is shaded in FIG. 3A. An analysis of an exemplary embodiment, where an optical flip-flop device of the present invention is biased such that Δω₀=2/τₚₕ and P₀=1/γτₚₕ² (as indicated by a star in FIG. 3A) is provided below.

Phase Modulation of Two-Input Bistable Resonators

Phase switching dictates that input phases of the two beams may change with time such that Aᵢₙ^{(k)}(t)=\sqrt{P₀}exp[iφₖ(t)]. A time-dependent phase is equivalent to imposing a frequency chirp which, in turn, modifies the biasing conditions in a transient fashion. Mathematically, an instantaneous change in the detuning of an input beam from resonance is given by:

$$Δ {ω}_{k} ( t ) = Δ {ω}_{0} - \frac{d {φ}_{k}}{d t} . \qquad ( 6 )$$

This change in detuning modifies the available steady states towards which the system will evolve. FIG. 3B shows the behavior of the solutions of equation (5) when Δω₂τₚₕ deviates from its bias value of −2. Stability of each possible solution was examined through a linear stability analysis of equations (1) and (2). The solid and dashed lines show stable and unstable solutions, respectively. FIG. 3B shows that the system will evolve toward a stable state in which T₁ is high and T₂ is low during the time for which Δω₂ is increased from its bias value. If the system is initially in a state for which T₁ is low and T₂ is high, a phase modulation of beam 2 can flip the device.

The phase of an input optical beam can be changed through a variety of techniques. For example, a phase modulator can be used for this purpose to switch a flip-flop electro-optically. An all-optical flip-flop can be switched using set and reset optical pulses at wavelengths that are different from those of the CW inputs used to bias the device. In devices and methods according to the present invention, the XPM phenomenon is used to modulate the phases of the two CW inputs. As an example, assuming a Gaussian shape for set and reset pulses of width T₀, the XPM-induced phase shift can be written in the form:

φₖ(t)=φ₀exp[(−(t−tₚ)²/T₀²], (7)

where φ₀ is the maximum phase shift occurring at the location t=tₚ. The phase modulation induces a negative detuning of the CW bias beams for t<tₚ and a positive detuning for t>tₚ. The largest value of the detuning is approximately given by:

Δωₖ^{max}≈Δω₀+0.86φ₀/T₀. (8)

If the ratio φ₀=T₀ is sufficiently large (˜1/τₚₕ), and if this detuning is maintained for a duration long enough (˜τₚₕ) that the resonator can respond, then the phase modulation will flip the device.

Numerical Simulation

An exemplary device of the present invention is shown to flipflop in a robust manner through numerical simulation by first solving equations (1) and (2) for phase-modulated input beams. The set and reset operations are performed by applying Gaussian phase modulations of the form in equation (7) to input beams 2 and 1, respectively. A pulse width of T₀=2τₚₕ is assumed, for which simulations show that switching occurs over the range of maximum phase shifts 2.3<φ₀<9, leaving a broad window for phase error.

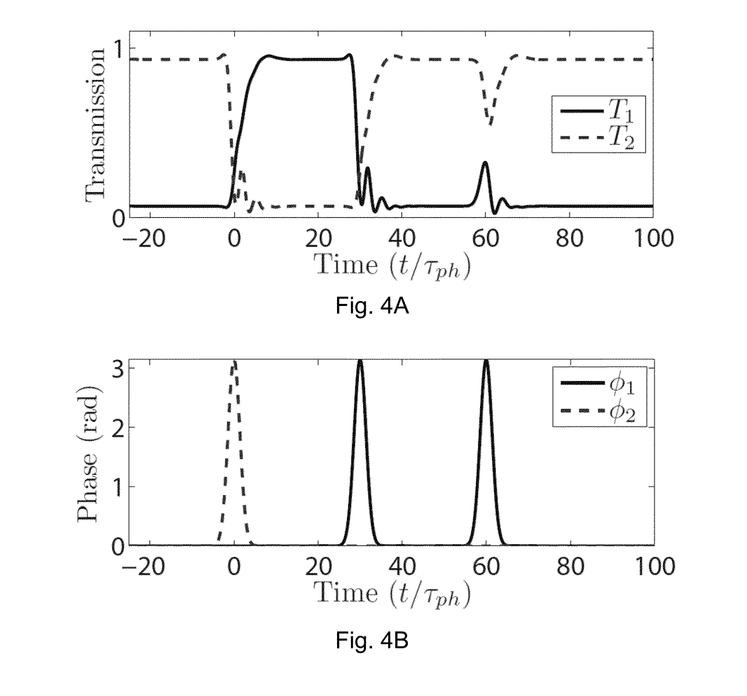

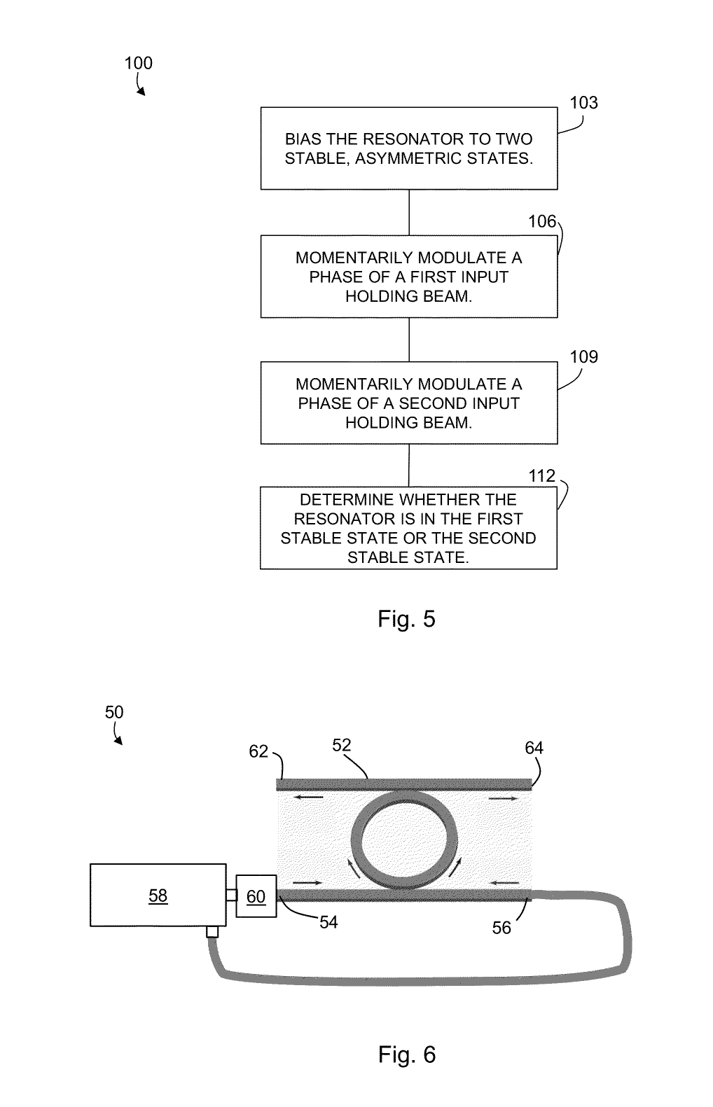

FIG. 4A shows the power transmissivity for each of the two output ports when the set and reset operations are applied to the two inputs as shown in FIG. 4B when φ₀=π. Initially, the cavity is full of clockwise propagating light, causing the XPM-induced shift in the counter-clockwise mode resonance frequency so that Aᵢₙ⁽¹⁾ is off resonance and T₁ is in the low state. When a set pulse modulates the phase of Aᵢₙ⁽²⁾, the flip-flop enters into a regime in which the only stable state is the one for which T₁ is high and T₂ is low. As a result, the system begins evolving towards this stable state. Physically, what happens during this process is that the cavity empties of clockwise-propagating light, reducing the XPM effect on the counter-clockwise mode so that Aᵢₙ⁽¹⁾ can resonantly excite it. After the phase modulation is complete the cavity has filled up with counter-clockwise propagating light such that T₁ is in the high state, and the device has flipped. A subsequent phase modulation of Aᵢₙ⁽¹⁾ by a reset pulse then causes the device to flop in an analogous fashion.

FIGS. 4A and 4B also show that, if two consecutive reset signals are applied, the second will not cause the device to flip anomalously. The leading edge of this second signal causes some modulation in the power at the output ports; however, its trailing edge reliably walks T₁ back into its low state in accordance with the reset operation.

In FIGS. 4A and 4B, the switching time is ˜τₚₕ for both the on and off states. Typical integrated resonators have photon lifetimes ˜10 ps that can be further reduced through a proper resonator design. Thus, switching times of under 50 ps are realistic for devices according to the present invention. For the setreset pulses, peak power levels required to obtain a π-phase shift by XPM in a silicon-based device of 2 W have been demonstrated, and lower values may be achievable.

The present invention may be embodied as a method 100 for phase-shift switching of a bistable optical resonator as a flip-flop, wherein the resonator has a first input and a second input. As such, the bistable resonator is switched between a first stable state and a second stable state. The resonator is biased 103 so as to have only two stable asymmetric states as described above. It should be noted that such biasing 103 may or may not make up a step of the present method 100 (e.g., the biasing 103 condition exists before implementation of the method 100). The method 100 comprises the step of modulating 106 the phase of the first input holding beam momentarily such that the resonator switches from the second stable state to the first stable state. The method 100 may further comprise the step of modulating 109 the phase of the second input holding beam momentarily such that the resonator switches from the first stable state to the second stable state.

The momentary modulation 106, 109 of the holding (input) beams can be considered as set/reset pulses of a flip-flop. The set and/or reset pulses of the method 100 may have a Gaussian shape.

The method 100 may further comprise the step of determining 112 whether the resonator is in the first stable state or the second stable state.

The present invention may be embodied as an flip-flop system 50 comprising a bistable optical resonator 52 having a first stable state and a second stable state. The resonator 52 has a first input 54 and a second input 56. The system 50 further comprises a optical source 58 (e.g., a laser source) for providing input holding beams to the first input 54 and the second input 56. The system 50 further comprises a modulator 60 configured to selectively modulate a phase of the first input 54 holding beam such that the resonator 52 is in the first stable state (either switching to the first stable state or remaining in the first stable state—depending on the initial state of the resonator 52). The modulator 60 may further be configured to selectively modulate a phase of the second input 56 holding beam such that the resonator 52 is in the second stable state (either switching to or remaining in the second stable state).

The resonator 52 may further comprise a first output 62, a second output 64, or both. The first output 62 and second output 64 may be used to determine the state of the resonator 52 (i.e., determine whether the resonator 52 is in the first stable state or the second stable state).

### Further Discussion and Embodiments

The model, further described below, makes no assumptions about the specific structure of a suitable optical cavity. The model describes exemplary embodiments of devices including, ring resonators, Fabry-Perot cavities illuminated by two input beams of the same frequency propagating at different angles (previously developed), and Fabry-Perot cavities with two resonator modes, having different resonance frequencies, propagating in the same direction. It is a dynamic model that can be used to describe the switching process, as well as the steady-state field behavior.

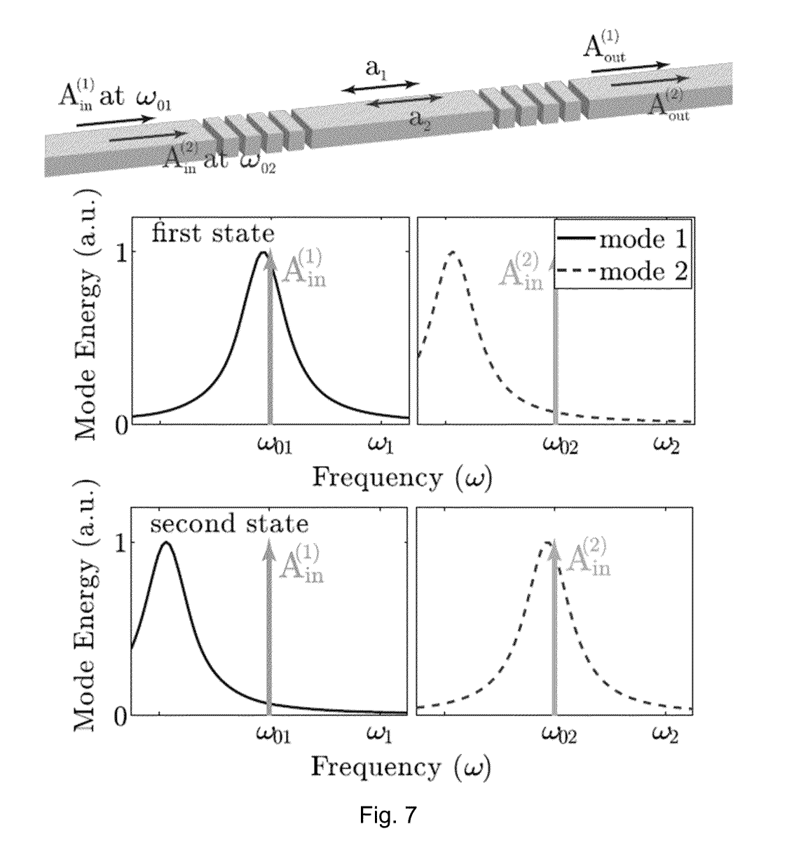

In this third configuration, a device (see, e.g., FIG. 7) functions because the XPM from the Kerr effect is twice as strong as SPM. Thus, if mode a₁ in FIG. 7 is intense enough so that it causes a Kerr-induced change in its own refractive index by Δnₙ₁, it will cause the refractive index experienced by any light in mode a₂ to change by 2Δnₙ₁. As a result of these index changes, both of the modes will experience shifts in their resonance frequencies, and the resonance shift of mode a₂ will be twice as large as the resonance shift of mode a₁. If the two input fields Aᵢₙ⁽¹⁾ and Aᵢₙ⁽²⁾ have the same intensity and are detuned from their initial (low-intensity) resonances by the same amount, this can lead to the existence of two stable states like the ones described in FIG. 7. In the first state, input field Aᵢₙ⁽¹⁾ at frequency ω₀₁ resonantly excites mode a₁ and fills the cavity with light. This causes input field Aᵢₙ⁽²⁾ at frequency ω₀₂ to be off resonance so that mode a₂ is only weakly excited. In this state, light at ω₀₁ is transmitted through the cavity and light at ω₀₂ is not. In the second state, the roles of the two input fields are reversed and the cavity transmits light at frequency ω₀₂ but not at ω₀₁.

A. Dynamic-Mode Amplitude Equations

The model expands on the known dynamic-mode theory of resonators. The electric field in the cavity is written as a sum of the two resonant modes that are excited by the input fields

$$E ( r , t ) = \frac{{a}_{1} ( t )}{\sqrt{{N}_{1}}} {e}_{1} ( r ) + \frac{{a}_{2} ( t )}{\sqrt{{N}_{2}}} {e}_{2} ( r ) , \qquad ( 9 )$$

where eₖ(r) is the electric-field profile associated with the kth mode (k=1, 2) of the resonator. The mode amplitudes are normalized so that |aₖ(t)|² is the electromagnetic energy stored in mode k at time t. The constant Nₖ is a normalization factor given by (10)

Nₖ=1/2∫∈₀∈(r)|eₖ|²d³r, (10)

where the dielectric permittivity ∈(r) describes the structure of the cavity.

When the medium inside the cavity exhibits the Kerr effect, there is, in addition to the linear response described by the permittivity, a nonlinear response described by the third-order dipole-moment density

$${P}_{μ}^{( 3 )} ( r , t ) = \frac{3 {ɛ}_{0}}{4} {\sum }_{α , β , γ} {x}_{μαβγ}^{( 3 )} {E}_{α} ( r , t ) {E}_{β}^{*} ( r , t ) {E}_{γ} ( r , t ) , \qquad ( 11 )$$

where x_{μαβγ}⁽³⁾ is the third-order susceptibility tensor. It has been shown that, for an itafly assumed solution of the form (9), Maxwell's equations imply the following equations for the mode amplitudes:

$$\frac{d {a}_{k}}{d t} = - i {ω}_{k} {a}_{k} - \frac{{a}_{k}}{2 {τ}_{ph}} + κ {A}_{in}^{( k )} ( t ) + \frac{i {ω}_{k}}{4 \sqrt{{N}_{k}}} \int {e}_{k}^{*} \cdot {P}^{( 3 )} {d}^{3} r , \qquad ( 12 )$$

where τₚₕ is the photon lifetime of the cavity; κ is a coupling coefficient; and Aᵢₙ^{(k)} is the input field to mode k, which is normalized so that |Aᵢₙ^{(k)}|² is its optical power. It is assumed for the sake of simplicity that τₚₕ and κ are the same for the two modes. Using equation (11) in equation (12) together with equation (9), we obtain the following two coupled nonlinear differential equations:

$$\begin{matrix}\frac{d {a}_{1}}{d t} = - i {ω}_{1} {a}_{1} - \frac{{a}_{1}}{2 {τ}_{ph}} + κ {A}_{in}^{( 1 )} ( t ) + i ( {γ}_{11} {\vert {a}_{1} \vert}^{2} + 2 {γ}_{12} {\vert {a}_{2} \vert}^{2} ) {a}_{1} , & ( 13 ) \\ \frac{d {a}_{2}}{d t} = - i {ω}_{2} {a}_{2} - \frac{{a}_{2}}{2 {τ}_{ph}} + κ {A}_{in}^{( 2 )} ( t ) + i ( {γ}_{22} {\vert {a}_{2} \vert}^{2} + 2 {γ}_{21} {\vert {a}_{1} \vert}^{2} ) {a}_{2} . & ( 14 )\end{matrix}$$

In deriving these equations, a number of terms have been neglected. Depending on which device configuration is being considered, there are different justifications for this neglect. For a configuration using two spectrally distinct modes, these additional terms are not frequency matched to the mode resonances, and hence they have a negligible influence on the mode amplitudes. In the case of modes that may have the same resonance frequency but are spatially distinct, such as counter-propagating modes in a ring resonator, these terms are vanishingly small as a result of the spatial phase structure of the modes.

The SPM and XPM terms appearing in equations (13) and (14) depend on a set of four nonlinear parameters given by (see also, equation (3))

$${γ}_{k l} = \frac{{ω}_{k} {n}_{2} c {η}_{kl}}{{{n}_{0}^{2} ( {V}_{k} {V}_{l} )}^{1 / 2}} , \qquad ( 15 )$$

In equation (15) Vₖ is an effective mode volume defined as

$${V}_{k} = \frac{{( \int ɛ ( r ) {\vert {e}^{( k )} \vert}^{2} {d}^{3} r )}^{2}}{{n}_{0}^{4} \int {( {\vert {e}^{( k )} \vert}^{2} )}^{2} {d}^{3} r} . \qquad ( 16 )$$

The parameter n₂ that appears in equation (15) is the Kerr coefficient responsible for the intensity dependence of refractive index in the nonlinear medium. In general, n₂ depends on the orientation of the electric field with respect to the crystallographic axes. In practice, n₂ is chosen to be the value for some particular crystallographic direction. The third-order susceptibility x_{c}⁽³⁾ in this direction is related to n₂ as

x_{c}⁽³⁾=4/3∈₀cn₀²n₂, (17)

where n₀ is the linear (low-intensity) refractive index of the medium. The parameter nₖₗ that appears in equation (15) is a nonlinear overlap factor given by

$${η}_{kl} = {\sum }_{μαβγ} \frac{\int {x}_{μαβγ}^{( 3 )} {e}_{μ}^{* ( k )} {e}_{α}^{( k )} {e}_{β}^{* ( l )} {e}_{γ}^{( l )} {d}^{3} r}{{{x}_{c}^{( 3 )} [ \int {( {\vert {e}^{( k )} \vert}^{2} )}^{2} {d}^{3} r \int {( {\vert {e}^{( l )} \vert}^{2} )}^{2} {d}^{3} r ]}^{1 / 2}} . \qquad ( 18 )$$

Physically, the nonlinear overlap factors measure how effectively the modes interact through the third-order susceptibility. It is often a good approximation to take nₖₗ≈1. It is also often a good approximation to take Vₖ≈V_{cav}, where V_{cav} is the volume of the cavity. If the two input fields additionally have nearly the same frequency, then γ₁₁≈γ₂₂≈γ₁₂≈γ₂₁≈γ, where

γ≈ω₁cn₂(n₀²V_{cav}) (19)

This approximate form of γ will be used throughout the rest of this section.

B. Steady-State Solutions

Equations (13) and (14) describe the behavior of the resonator for any input-field temporal profiles Aᵢₙ⁽¹⁾(t) and Aᵢₙ⁽²⁾(t). For designing an optical flip-flop, we are interested in the stable, steady states of the resonator when two continuous-wave (CW) fields with constant intensities are launched into it. The input fields then take the form

$${A}_{in}^{( k )} ( t ) = {B}_{k} {e}^{- {iω}_{0 k} t} , \qquad ( 20 )$$

where Bₖ are constants. For such input fields, the steady-state solutions of equations (13) and (14) take the form

$${a}_{k} ( t ) = {b}_{k} {e}^{- i {ω}_{0 k} t} , \qquad ( 21 )$$

Using equations (20) and (21) in equations (13) and (14), we obtain a pair of algebraic equations for the complex constants bₖ,

[−i(Δωₖ+γ|bₖ|²+2γ|b₃₋ₖ|²)+1/2τₚₕ]bₖ=κBₖ, (22)

where Δωₖ=ω₀ₖ−ωₖ is the detuning of the kth input field from resonance. These equations result in the following pair of coupled equations for the mode energies Eₖ=|bₖ|²,

[(Δωₖ+γEₖ+2γE₃₋ₖ)²+(1/2τₚₕ)²]Eₖ=|κ|²Pₖ, (23)

where Pₖ=|Bₖ|² is the power of the kth input field. Once a solution is found for the mode energies by solving equation (23), equation (22) can be used to find the phases of bₖ.

Solving equation (23) does not, however, guarantee that the resulting solution represents a physically realizable state of the device. In order to be realizable, it is also necessary that the solution be stable. A stable solution is characterized by its being robust to small perturbations. If a small perturbation is applied to a stable state, it tends to die out and the system remains in that state. In contrast, if a small perturbation is applied to an unstable state, the system evolves away from that state and does not return to it. Stability of various solutions of equation (23) can be examined by performing a linear stability analysis of equations (13) and (14), as outlined in the following discussion.

Linear Stability Analysis

Consider the solutions of equation (22) for the mode amplitudes bₖ. These correspond to steady-state solutions of equations (13) and (14) of the form of equation (21). Now imagine that the fields are slightly perturbed, such as would occur regularly in a real device. After the perturbation the solutions of equations (13) and (14) can be written in the form

$${a}_{k} ( t ) = {b}_{k} [ 1 + {c}_{k} ( t ) ] {e}^{- i {ω}_{0 k} t} , \qquad ( 24 )$$

Where |cₖ|<<1. Using this form in equations (13) and (14), the fact that bₖ satisfy equation (22), and neglecting all terms higher than the first order in cₖ, we obtain a system of four differential equations that describe how the perturbation evolves in time. We can write them in matrix form as

$$\frac{d c}{d t} = i γ \overleftrightarrow{S} c , \qquad ( 25 )$$

where c=[c₁ c₂ c₁*c₂*]^{T} is a column vector and the matrix [symbol] is given by

$$\overleftrightarrow{S} = ( \begin{matrix}{q}_{1} & 2 {E}_{2} & {E}_{1} & 2 {E}_{2} \\ 2 {E}_{1} & {q}_{2} & 2 {E}_{1} & {E}_{2} \\ - {E}_{1} & - 2 {E}_{2} & - {q}_{1}^{*} & - 2 {E}_{2} \\ - 2 {E}_{1} & - {E}_{2} & - 2 {E}_{1} & - {q}_{2}^{*}\end{matrix} ) , \\ where {q}_{k} = 2 ( {E}_{1} + {E}_{2} ) + ( {Δω}_{k} + \frac{i}{2 {τ}_{ph}} ) \text{/} γ . \qquad ( 26 )$$

Any solution of equation (25) can be written as a linear combination of its eigenmodes. The eigenmodes are constructed from the eigenvectors and corresponding eigenvalues of the matrix [symbol] which satisfy

[symbol]

cₘ=λₘcₘ. (27)

The eigenmode solutions are given by cₘe^{iγλ}^{ₘ}^{t}. If any of these eigensolutions grow exponentially in time, then it is possible for a small perturbation to drive the modes away from the steady-state solutions bₖ, indicating that they are unstable. If, on the other hand, all of the eigensolutions decay exponentially in time, then the solutions bₖ are stable. This occurs when all of the eigenvalues Aₘ satisfy

Im{λₘ}>0, (28)

which is the criterion used to determine the stability of steady-state solutions in this disclosure.

Flip-Flop Design Criteria

A. Biasing Conditions

The available stable states of the flip-flop depend on the power levels and detunings of the two input fields, as indicated by equation (23). The flip-flop could be designed such that these properties are different between the two fields, but this would be undesirable. As discussed above, thermal nonlinearities can be a problem for a flip-flop having different intracavity intensities in its two states. As a result, it is desirable to bias the device symmetrically so that the input fields have the same power and detuning from their respective resonances. In this situation, we can expect a pair of states to exist that exhibit the same intracavity energy, such as those depicted in FIG. 7. Mathematically, these states are found by solving equation (23) with the conditions

Δω₁=Δω₂Δω₀, (29)

P₁=P₂=P₀, (30)

and then examining their stability using the linear stability analysis presented above.

It is known that the solutions of equation (23) under symmetric biasing conditions can be divided into two categories. The first category contains all symmetric solutions, characterized by the equality of their mode energies (E₁=E₂). The second category contains all asymmetric solutions for which E₁≠E₂. Because the biasing conditions are themselves symmetric, the asymmetric solutions come in pairs because the roles of E₁ and E₁ can always be reversed.

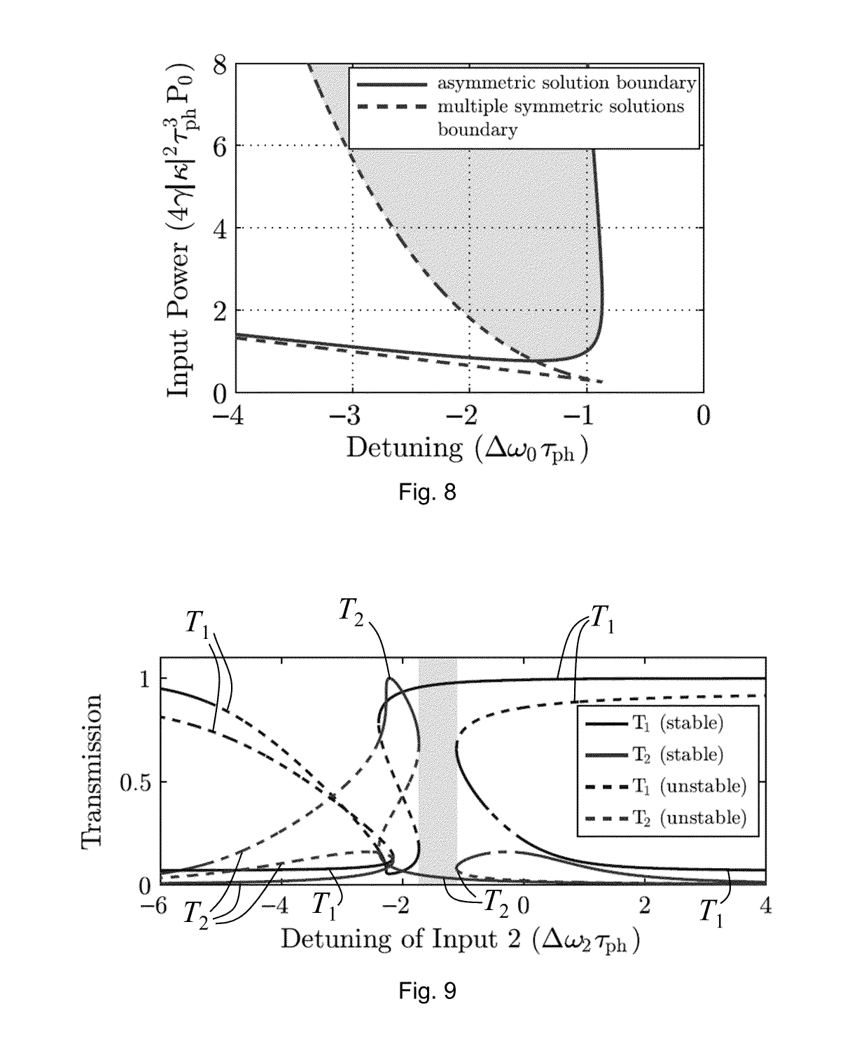

The solutions depicted in FIG. 7 for the two states of a flip-flop are a pair of asymmetric solutions. For a flip-flop, it is necessary to choose P₀ and Δω₀ so that such a pair of solutions exists at that bias point. An preferred bias point will also have the property of supporting no other stable states. If, for example, there were a stable symmetric solution in addition to the asymmetric pair, then the flip-flop might slip into this undesirable state and stop working. FIG. 8 shows the set of preferred bias points in the (Δω₀, P₀) plane, following a known analysis. The solid curve in the figure bounds the set of bias points that support asymmetric solutions. The dashed curve bounds the set of bias points for which multiple symmetric solutions exist. Bias points in this second set are not preferred because one of the symmetric solutions is always found to be stable. Thus, the preferred bias points lie in the shaded region of FIG. 8. The flip-flop can operate at any of these preferred bias points. In the following analysis, as an example, we focus on a particular bias point by choosing Δω₀τₚₕ=−2 and power P₀ such that 4γ|κ|²τₚₕ³P₀=2. The results of this analysis apply qualitatively to other preferred bias points as well. The differences among them are quantitative in nature. They will, for instance, exhibit different extinction ratios between the high and low transmission states of the flip-flop. Additionally, the relative robustness of phase switching will vary among them.

B. Phase-Modulation Profile

We consider switching of the two-input Kerr resonator by pure phase modulations of the input fields. This phenomenon is modeled by solving equations (13) and (14) with input fields of the form

$${A}_{in}^{( k )} ( t ) = {B}_{k} {e}^{i {φ}_{k} ( t ) - i {ω}_{0 k} t} , \qquad ( 31 )$$

where φₖ (t) is a time-dependent phase imposed on the field by a control signal. This could be accomplished electrically by using an electro-optic phase modulator, or optically using XPM of an input field by a set or reset pulse. The result of this phase modulation is to temporarily change the detuning of the field's frequency from resonance as

$$Δ {ω}_{k} ( t ) = Δ {ω}_{0 k} - \frac{d {φ}_{k}}{d t} . \qquad ( 32 )$$

If the phase modulation is slow enough for the resonator to respond, then its effect can be understood as temporarily modifying the biasing conditions and, hence, the available stable states toward which the system will evolve.

The phase switching of an optical flip-flop can be understood using FIG. 9, where the available stable states are plotted as a function of detuning (Δω₂τₚₕ) of input field 2, while the detuning of input field 1 and the power levels of both fields are kept constant at the bias point: Δω₁τₚₕ=−2 and 4γ|κ|²τₚₕ³P₀=2. The transmission of mode k is calculated using

Tₖ=|κaₖ/Aᵢₙ^{(k)}|². (33)

We assume that resonator loss is dominated by the two couplers so that |κ|²=1/2τₚₕ. If a phase modulation with a positive derivative is applied to input field 2 so that Δω₂τₚₕ<−2, then FIG. 9 indicates that transmission of both fields will drop to a low state. When the phase modulation ceases and Δω₂Tₚₕ comes back to its bias value of −2, it is unclear in which state the system will end up. For this reason, this situation is not preferred for switching. If, on the other hand, a phase modulation with a negative derivative is applied to input field 2 so that Δω₂τₚₕ>−2, the device enters the shaded region in FIG. 9 where the only available state is one for which the transmission of field 1 is high but the transmission of field 2 is low. Thus, if the transmission of field 2 is initially in the high state, such a phase modulation can force the device to flip. In an analogous way, a subsequent phase modulation of input field 1 can cause the device to flop.

In practice, it may be necessary to turn off the signal that applies the modulation after a short time interval. As an example, we consider Gaussian phase shifts of the form

$${φ}_{k} ( t ) = {φ}_{0} {e}^{- {( t - {t}_{p} )}^{2} / {T}_{0}^{2}} , \qquad ( 34 )$$

where φ₀ is the maximum phase shift occurring at time tₚ, and T₀ is a measure of the temporal duration of the phase modulation. Positive values of φ₀ allow for switching to occur because the trailing edge of the modulation determines the final state of the device after the signal is gone. Thus, even though a positive value of φ₀ increases the phase over the leading edge of the signal, which does not necessarily switch the device, the trailing edge creates a decreasing phase shift that can switch the device under the appropriate conditions. Maximum detuning can be derived using equations (32) and (34) and is found to be

Δωₖ^{max}≈Δω₀+0.86φ₀/T₀. (35)

In order for the device to switch, this maximum detuning should be large enough to drive the device into the shaded switching region in FIG. 9. This imposes a constraint on the maximum phase shift φ₀ and temporal duration T₀. Noting that Δω₂ should increase by about 1/τₚₕ, we obtain the following approximate criterion for switching of the flip-flop:

φ₀>T₀/τₚₕ. (36)

Equation (36) is not sufficient for a phase modulation to switch the device. Also, the modulation should occur over a long enough temporal duration that the resonator can respond. This leads to the following second criterion:

T₀>τₚₕ. (37)

The approximate criteria for the phase-modulation parameters in equations (36) and (37) are verified by rigorous numerical solutions of equations (13) and (14). The input fields are taken to be of the form of equation (31) with phase modulations of the form of equation (34). The flip-flop is biased using two CW fields with detunings Δω₀τₚₕ=−2 and powers given by 4γ|κ|²τₚₕ³P₀=2. As in FIG. 9, the resonator loss is assumed to be dominated by coupling so that |κ|²=1/2τₚₕ.

Initially, the flip-flop is in a state for which the transmission of input field 2 is high and the transmission of input field 1 is low. The impact of phase switching is then studied by applying three phase modulations of the form given in equation (34) at times tₚ=0, 50τₚₕ, and 100τₚₕ. The first modulation is applied to input field 2 (set operation) and the remaining two to field 1 (reset operations).

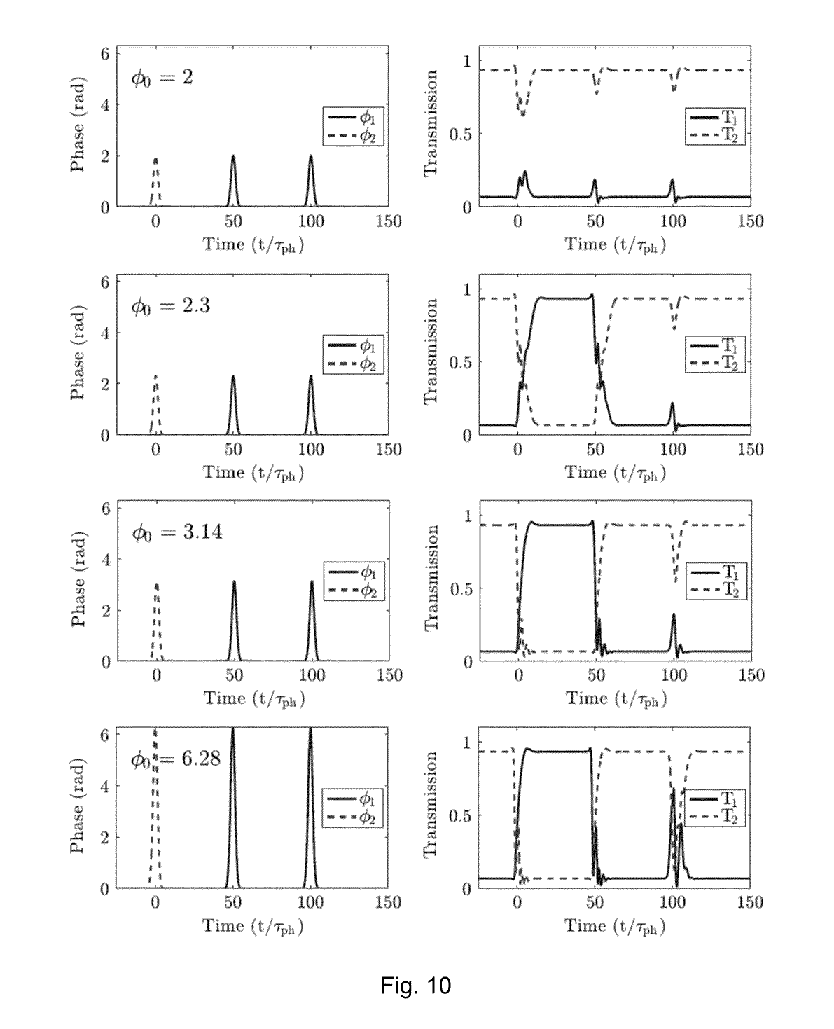

We consider first the role of the maximum phase shift φ₀ and fix the duration of the phase modulation at T₀=2τₚₕ. FIG. 10 shows the switching behavior for four values of φ₀ ranging from 2 to 2π. When φ₀=2, the set operation fails, indicating that this value of φ₀ is not large enough for the flip-flop to work. However, when φ₀ is slightly increased to 2.3, both the set and reset operations succeed, and the flip-flop turns on and off as expected. Note that this switching threshold agrees well with the criterion in equation (36). Note also that when two reset operations occur in succession, the second does not change the state of the device.

As the maximum phase shift is further increased to π and 2π, as shown in FIG. 10, the set and reset operations continue to succeed. Further simulations indicate that switching continues to succeed for maximum phase shifts up to φ₀≈9 but fails for still larger values. This upper limit occurs when the maximum detuning is Δωₖ^{max}τₚₕ≈1.9 according to equation (35). This implies that phase switching is even more robust than can be ascertained from FIG. 9, and it succeeds when phase modulations shift the detuning of field 2 well to the right of the shaded ideal-switching region shown there. From a practical perspective, there is a wide range of φ₀ values over which phase switching succeeds.

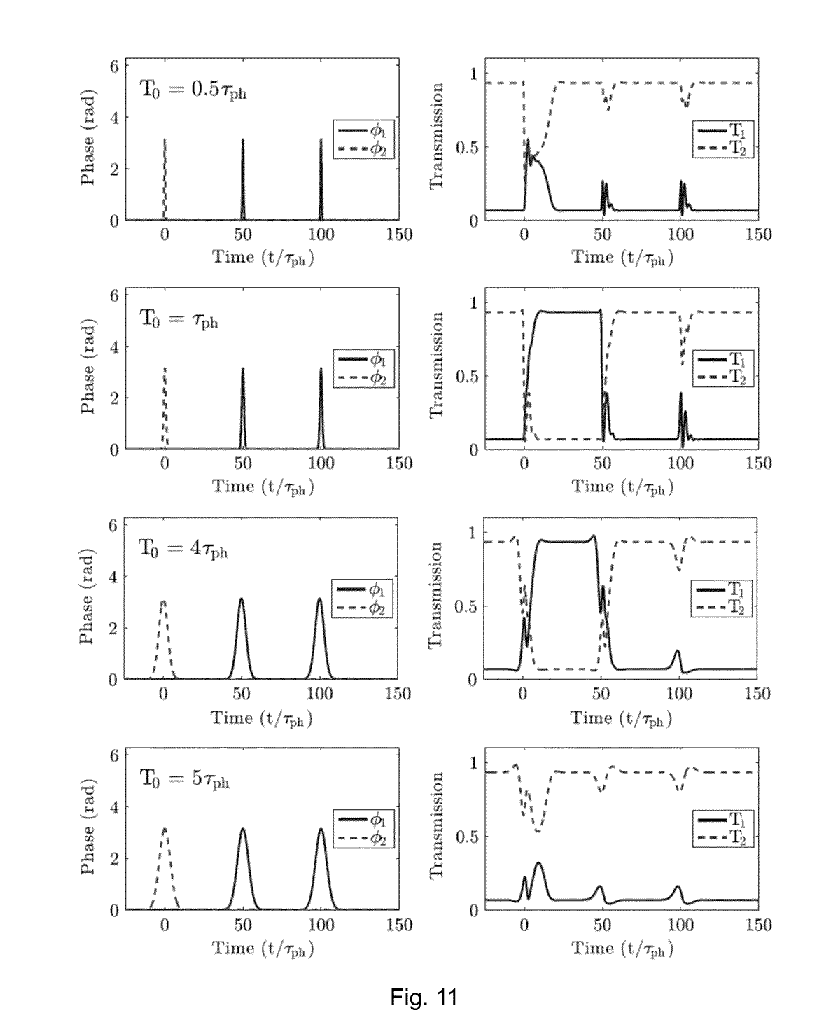

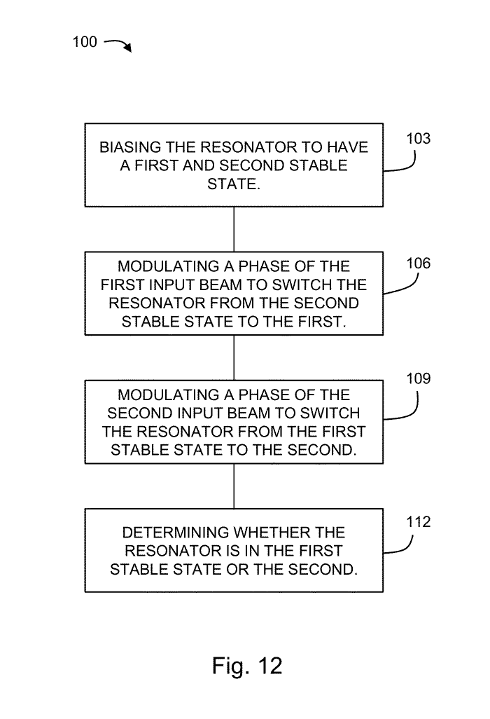

We consider next the role of the duration T₀ of the phase modulation. For this purpose, we fix the maximum phase shift at a value of φ₀=π. FIG. 11 shows the switching behavior for four values of the duration T₀. When T₀=τₚₕ/2, the set operation fails, indicating that the phase is changed so fast that the resonator is unable to respond to it. When the duration is increased to T₀=τₚₕ, the set and reset operations succeed. Note that this switching threshold agrees well with the criterion in equation (37). As T₀ is increased to 4τₚₕ, the switching continues to succeed. However, if T₀ is further increased to 4τₚₕ, the set operation fails. The reason for this failure can be understood by noting that the criterion in equation (36) does not hold for the values of T₀ and φ₀ used in this last case.

Cavity Design Considerations

The analysis has so far assumed only one kind of material nonlinearity: the Kerr effect. There are, however, other effects associated with a given material system.

Semiconductors often exhibit nonlinear loss mechanisms such as two-photon absorption and subsequent free-carrier absorption, which are may prevent the device from functioning. If optical fields were employed with photon energies below the half-bandgap, this problem could be avoided so that the large Kerr nonlinearity of semiconductors could be leveraged for low-power operation. Other candidate material systems include silicon dioxide and silicon nitride. Neither of these exhibit significant nonlinear absorption near the 1.55 μm wavelength, and fabrication of resonators is technologically well developed for both of these materials.

There is one type of material nonlinearity that cannot be avoided. Even if the medium is nearly transparent, some optical power is always lost through material absorption. As discussed in above, this absorption heats the cavity and changes its refractive index via the thermo-optic effect. For a two-input flip-flop, this thermal index change does not affect the switching process because it has the same value in both of the stable states and responds on a time scale much longer than that required for switching. It does, however, present two practical problems. First, if the temperature change is large enough it can physically damage or destroy the resonator. Second, it presents a technical challenge for turning on the device. The reason for this can be understood as follows: in the cold-cavity state, before the input fields are turned on (i.e., when Aᵢₙ⁽¹⁾=Aᵢₙ⁽²⁾=0) the kth mode's resonance frequency is ωₖ. In the operation mode, when both lasers are on and bistability has been achieved, the new resonance frequency is ωₖ′=ωₖ+Δω_{T}Δω_{Kerr}^{(k)}, where Δω_{T} is the resonance shift from the cavity's change in temperature, and Δω_{Kerr}^{(k)} is the resonance shift from the Kerr effect. When the lasers are first turned on, they might be so far from the cold-cavity resonances that neither input field is able to couple into the cavity and heat it up. As a result, simply turning the lasers on will not transition the device from the cold-cavity state into operation mode. In order to do this, it may be necessary to come up with a means of heating the cavity. This could be done using a thermo-electric temperature controller, or by sweeping the frequency of one of the input fields to “drag” the cold-cavity resonances close to the operation frequency. Either way it will be desirable that Δω_{T}, be small compared to Δω_{Kerr}^{(k)}). Its value will depend on the materials used to make the device as well as on the geometric structure of the resonator.

A. Simple Thermal Model

To analyze the influence of material properties on the temperature shifts that are responsible for Δω_{T}, we develop a thermal model of the device. Consider the influence of a weak material absorption on the cavity's photon lifetime. The overall photon lifetime is given by

$$\frac{1}{{τ}_{ph}} = \frac{1}{{τ}_{ph}^{ab}} + \frac{1}{{τ}_{ph}^{sc}} + \frac{1}{{τ}_{ph}^{e}} , \qquad ( 38 )$$

where τₚₕ^{ab}, τₚₕ^{sc}, and τₚₕ^{e} represent contributions from material absorption, ph phph scattering losses, and coupling losses, respectively. Using the perturbative theory disclosed above, it can be shown that the contribution from material absorption is given by

$$\frac{1}{{τ}_{ph}^{ab}} \approx \frac{c {α}_{m}}{{n}_{0}} , \qquad ( 39 )$$

where it has been assumed that the optical field is primarily confined to a single material with absorption coefficient αₘ and refractive index n₀. By considering the rate at which electromagnetic energy is lost owing to this absorption, we find that the thermal energy ΔU_{T} stored in the cavity changes with time as

$$\frac{d Δ {U}_{t}}{d t} = \frac{c {α}_{m}}{{n}_{0}} ( {\vert {a}_{1} \vert}^{2} + {\vert {a}_{2} \vert}^{2} ) - \frac{Δ {U}_{T}}{{τ}_{T}} , \qquad ( 40 )$$

where τ_{T} is the thermal lifetime.

The thermal energy is related to the thermo-optic change in refractive index as

$$Δ {n}_{T} = \frac{( \partial n \text{/} \partial T ) Δ {U}_{T}}{ρ {C}_{ρ} {V}_{cav}} , \qquad ( 41 )$$

where ∂n/∂T is the medium's thermo-optic coefficient, Cₚ is its specific heat capacity, and ρ is its density. Equations (40) and (41) indicate that Δn_{T} evolves with time as

$$\frac{d Δ {n}_{T}}{d t} = \frac{( \partial n \text{/} \partial T ) c {α}_{m}}{{n}_{0} ρ {C}_{ρ} {V}_{cav}} ( {\vert {a}_{1} \vert}^{2} + {\vert {a}_{2} \vert}^{2} ) - \frac{Δ {n}_{T}}{{τ}_{T}} . \qquad ( 42 )$$

Equation (42) describes how the optical field in the resonator influences the thermal index shift. The influence of the index shift Δn_{T} on the mode amplitudes is incorporated in the dynamic equations (13) and (14) by adding another term so that they become

$$\frac{d {a}_{k}}{d t} = - i {ω}_{k} {a}_{k} - \frac{{a}_{k}}{2 {τ}_{ph}} + κ {A}_{in}^{( k )} ( t ) + i γ ( {\vert {a}_{k} \vert}^{2} + 2 {\vert {a}_{3 - k} \vert}^{2} ) {a}_{k} + i {ω}_{k} \frac{Δ {n}_{T}}{{n}_{0}} {a}_{k} . \qquad ( 43 )$$

The last term in this equation represents a thermally induced shift of the cavity's resonance frequency by an amount Δω_{T}=ωₖΔn_{T}/n₀.

The thermal resonance shift of the device in operation mode can be calculated by considering the steady-state solution of equations (42) and (43), and it is found to be

$$Δ {ω}_{T} = - \frac{{ω}_{k} {τ}_{T} c {α}_{m} ( \partial n \text{/} \partial T )}{{n}_{0}^{2} ρ {C}_{ρ} {V}_{cav}} {E}_{cav} , \qquad ( 44 )$$

where E_{cav}=E₁+E₂ is the optical energy stored in the cavity. Because the optical field in the cavity is dominated by one mode in each of the states (e.g., the kth mode), the optical energy can be approximated by that of this dominant mode (E_{cav}≈Eₖ). With this approximation, the Kerr-induced resonance shift of the dominant mode can be shown from equation (43) to be

$$Δ {ω}_{Kerr} = - \frac{{ω}_{1} {cn}_{2}}{{n}_{0}^{2} {V}_{cav}} {E}_{cav} , \qquad ( 45 )$$

where equation (19) has been used for γ. Equations (44) and (45) imply that the ratio of the thermal resonance shift to the Kerr-induced resonance shift is

$${ϒ}_{T} = \vert \frac{Δ {ω}_{T}}{Δ {ω}_{Kerr}} \vert = \frac{{τ}_{T} {α}_{m} ( \partial n \text{/} \partial T )}{ρ {C}_{ρ} {n}_{2}} . \qquad ( 46 )$$

Because γ_{T} depends primarily on material properties, it can be seen as a figure of merit for comparing candidate material systems out of which to construct the resonator. The only term in equation (46) that is not purely a material parameter is τ_{T}, which measures how quickly the cavity dissipates heat with the surrounding environment and has some dependence on its geometric structure. Active cooling of the cavity can reduce the effective value of τ_{T} and improve the figure of merit. Models that show the influence of material properties and cavity structure on τ_{T} have also been developed in for different types of cavities.

B. Influence of Resonator Structure

The resonator structure affects two parameters, the quality factor (Q) and cavity volume (V_{cav}), that influence device performance. Both of these should be selected so that the flip-flop can be made with a low enough bias power, low enough operating temperature, and fast enough speed.

The power of each of the input fields at the bias point that we have used in the preceding analysis is given by 2γτₚₕ²P₀=2 when the resonator loss is dominated by coupling. Using this expression and equation (19) for γ leads to the following estimate of the required bias power:

$${P}_{0} \approx ( \frac{{V}_{cav}}{{Q}^{2}} ) \frac{{ω}_{1} {n}_{0}^{2}}{{cn}_{2}} . \qquad ( 47 )$$

This relation shows that the required power is proportional to the volume of the cavity. This makes sense because a smaller volume will require less input power to achieve the same intracavity intensity and therefore the same Kerr-induced resonance shift. Equation (47) also indicates that the needed bias power depends inversely on Q². Physically, one factor of Q results from the fact that a larger quality factor implies a proportionately higher cavity enhancement of the optical power of an input field. The other factor of Q comes from the fact that a larger quality factor implies a proportionately smaller bandwidth of the cavity resonance. Bistable operation is achieved when the Kerr-induced shift of a resonance is comparable to its bandwidth. Because the Kerr-induced shift is proportional to the optical power inside the cavity, a smaller bandwidth results in a proportionately lower requirement for the bias power.

The temperature shift of the cavity when the flip-flop becomes operational is also important because too much heating can damage it. The temperature shift can be calculated by solving equation (40) for the steady-state thermal energy in the cavity and using the relation ΔT=ΔU_{T}/ρC_{ρ}V_{cav}, where ΔT is the temperature shift. The result is

$$Δ T \approx ( \frac{1}{Q} ) \frac{2 {τ}_{T} {α}_{m} {n}_{0}}{{n}_{2} ρ {C}_{ρ}} , \qquad ( 48 )$$

where the steady-state intracavity energy has been approximated by E_{cav}≈2/γτₚₕ and equation (19) has been used for γ. Equation (48) indicates that the operating temperature depends inversely on the quality factor, but that it does not depend on the cavity volume. The independence on cavity volume results from the fact that the required power scales with V_{cav} [equation (47)]. Thus, the intracavity intensity and, hence, the operating temperature do not depend on V_{cav} when the device is appropriately engineered. The inverse dependence of the operating temperature on Q occurs because a smaller Kerr-induced frequency shift is needed if the resonator has a higher quality factor. The Kerr-induced resonance shift and the thermal resonance shift are directly proportional [equation (46)], and the thermal shift is directly proportional to the change in temperature. A higher Q therefore implies a proportionately smaller temperature shift.

It might be concluded from equations (47) and (48) that it is desirable to design the cavity to have the largest Q possible. However, this is not necessarily the case because the quality factor also determines the device's switching speed. Numerical simulations in FIG. 10 indicate that the temporal duration over which the flip-flop switches between states can be as small as T_{sw}=5τₚₕ. Noting that Q=ω₁τₚₕ, a higher quality factor results in a longer switching time.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

1. A flip-flop system comprising:
An optical resonator having a first stable state and a second stable state, where the resonator has a first input and a second input;
an optical source configured to provide a first input beam to the first input and a second input beam to the second input; and
a modulator configured to selectively modulate a phase of the first input beam such that the resonator is in the first stable state.

2. The system of claim 1, wherein the modulator is further configured to selectively modulate a phase of the second holding beam such that the resonator is in the second stable state.

3. The system of claim 1, wherein the resonator further comprises a first output configured to provide a signal when the resonator is in the first state.

4. The system of claim 3, wherein the resonator further comprises a second output configured to provide a signal when the resonator is in the second state.

5. The system of claim 1, wherein the resonator is a micro-ring resonator.

6. The system of claim 1, wherein the optical source comprises two optical sources.

7. A method for switching a bistable optical resonator as a flip-flop, wherein the resonator has a first input and a second input, the method comprising the steps of:
biasing the resonator to have a first stable state and a second stable state, wherein the first and second stable states are asymmetric;
modulating a phase of a first input beam to switch the resonator from the second stable state to the first stable state.

8. The method of claim 7, further comprising the step of modulating a phase of a second input beam to switch the resonator from the first stable state to the second stable state.

9. The method of claim 7, wherein the first input beam is modulated for a duration of time that is greater than or equal to the photon lifetime of a cavity of the resonator.

10. The method of claim 7, wherein the first input beam is modulated such that a maximum phase shift of the modulated beam is greater than or equal to 2.3 radians.

11. An optical flip-flop device, comprising:
an optical resonator having two excited modes, the resonator comprising:
a first input configured to receive a first input beam;
a second input configured to receive a second input beam;
a first output; and
a second output;
wherein the resonator is configured such that modulating a phase of the first input beam or a phase of the second input beam switches a transmission of the resonator at the first output and/or second output.
